(19) United States
(12) Patent Application Publication
(10) Pub. No.: US 2005/0048996 A1
(43) Pub. Date: Mar. 3, 2005

(54) Locking system and method for same

(76) Inventors: Rafael J. Cobo, North Miami Beach, FL (US); Deliana Castro-Gomez, Miami, FL (US); Gonzalo E. Labarca, Boca Raton, FL (US); Oscar J. Pichardo, Parkland, FL (US); Lawrence R. Stotts, Elgin, IL (US)

Correspondence Address: Larry G. Brown;Motorola, Inc., Law Department, 8000 West Sunrise Boulevard, Fort Lauderdale, FL, 33322, US

(21) Appl. No.: 10/649,570

(22) Filed: Aug. 26, 2003

(51) Int. Cl. H04M 1/00

(52) U.S. Cl. 455/550.1

(57) ABSTRACT

The present invention concerns a locking system (100). The locking system includes a plate (110) having a first projection (130) and a second projection (132). At least a portion of the first projection runs at least substantially along a vertical axis (V₁) of the plate, and the plate also includes a surface area (126) for receiving a decorative image (128). The locking system further includes a base (112) having a first slot (136) and a second slot (138) in which the first slot and the second slot run at least substantially along horizontal axes (H₁, H₂) of the base. The first slot detachably receives the first projection when the plate is in a first position, and the second slot detachably receives the second projection as the plate is turned to a second position.

### CROSS REFERENCE TO RELATED APPLICATIONS

(Not Applicable)

### BACKGROUND

1. Technical Field

This invention relates in general to locking mechanisms and more particularly, to a locking mechanism for a removable plate.

2. Description of the Related Art

Many manufacturers sell accessories for mobile communications units, such as cellular telephones. For example, consumers may purchase aftermarket products such as removable face plates, portable chargers that permit a user to charge a phone in his or her car and audio headsets. Some consumers may wish to embellish these accessories with cultural icons, particularly icons that are associated with the sporting world.

As an example, a user of a cellular telephone may wish to place on his or her phone a mark associated with a particular sporting team. Currently, however, there is no system or method in place that permits a user to position securely such a mark on a phone or an accessory.

### SUMMARY OF THE INVENTION

The present invention concerns a locking system. The locking system includes a plate and a base. The plate has a first projection and a second projection in which at least a portion of the first projection runs at least substantially along a vertical axis of the plate. The plate also includes a surface area for receiving a decorative image. The base has a first slot and a second slot in which the first slot and the second slot run at least substantially along horizontal axes of the base. The first slot detachably receives the first projection when the plate is in a first position, and the second slot detachably receives the second projection as the plate is turned to a second position. The first slot locks the first projection, and the second slot locks the second projection when the plate is in the second position such that the plate is detachably coupled to the base.

In one arrangement, the second slot can unlock the second projection as the plate is turned from the second position to the first position. In addition, the first slot can unlock the first projection when the plate is in the first position such that the plate can be removable from the base.

In another arrangement, the first projection can have a center portion that is at least substantially circular, and at least one wing that can be attached to and can project away from the center portion. The first slot can include at least one arc that can engage the center portion of the first projection and at least one extension that can receive the wings of the first projection. The base can include a first element and a second element in which the first element can be affixed to the second element. The first element can have a top surface and a bottom surface, and the bottom surface can engage the wings as the plate is turned to and stops at the second position.

As an example, the second projection can include a neck and a head in which the neck can be attached to the plate, and the head can be attached to the neck. The second slot can include a pair of opposing projections in which each projection can have an arc. The arcs can snap lock the neck of the second projection when the plate is in the second position.

In yet another arrangement, the base can further include a speaker and a handle. A user can position the speaker in an ear of the user, and the user can grasp the handle when the user wishes to insert the speaker in the user's ear and when the user wishes to remove the speaker from the user's ear. The plate can further include a handle in which a user can grasp and turn the handle when the user wishes to turn the plate from the first position to the second position and from the second position to the first position.

The present invention also concerns another locking mechanism. The system includes a plate having a first projection and a second projection and a base having a first slot and a second slot. The first slot and the second slot detachably lock the first projection and the second projection to permit the plate to detachably couple the base. The plate includes a surface area for receiving a decorative image. Also, a user selectively detachably couples the plate to the base by turning the plate from a first position to a second position and from the second position to the first position.

The present invention also concerns a plate for an audio device. The plate includes a first surface area, a second surface area for receiving a decorative image, a first projection and a second projection in which the first and second projections are disposed on the first surface area. The first and second projections detachably engage a first slot and a second slot of a base of the audio device. In addition, the plate couples to the base when the first and second projections engage the first and second slots, and the plate decouples from the base when the first and second projections disengage the first and second slots of the base. The first and second projections of the plate disengage the first and second slots of the base when the plate is turned to a first position, and the first and second projections engage the first and second slots when the plate is turned to a second position.

The present invention also concerns a base of an audio device. The base includes a first element having a first slot and a second slot and a second element having a speaker in which the first element is attached to the second element. The first and second slots detachably engage first and second projections of a plate of the audio device. The base couples to the plate when the first and second slots engage the first and second projections, and the base decouples from the plate when the first and second slots disengage the first and second projections of the plate. In addition, the first and second slots of the base disengage the first and second projections of the plate when the plate is turned to a first position, and the first and second slots engage the first and second projections when the plate is turned to a second position.

The present invention also concerns a method of detachably securing a plate to a base of an audio device. The method can include the steps of inserting a first projection of the plate into a first slot of the base in which the plate is in a first position, turning the plate towards a second position in which the first slot engages the first projection, guiding a second projection of the plate into a second slot during the turning the plate step and engaging the second slot with the second projection in which the plate is in the second position.

The method can also include the steps of disengaging the second projection from the second slot, turning the plate towards the first position and removing the first projection from the first slot when the plate reaches the first position. In one arrangement, the plate can have a handle, and the base has a handle. The handle of the plate can be at approximately a ninety degree angle with respect to the handle of the base when the plate is in the first position. In another arrangement, the handle of the plate can be at least substantially parallel with the handle of the base when the plate is in the second position.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a perspective view of a system having a locking mechanism in accordance with the inventive arrangements;

FIG. 2 is an exploded side view of the system of FIG. 1 in accordance with the inventive arrangements;

FIG. 3 illustrates several components of the system of FIG. 1 in accordance with the inventive arrangements;

FIG. 4 illustrates a method of operating the system of FIG. 1 in accordance with the inventive arrangements;

FIG. 5 illustrates a portion of the system of FIG. 1 in a first position in accordance with the inventive arrangements;

FIG. 6 illustrates a side view of the system as shown in FIG. 5 in accordance with the inventive arrangements;

FIG. 7 illustrates a portion of the system of FIG. 1 in a second position in accordance with the inventive arrangements;

FIG. 8 illustrates a side view of the system as shown in FIG. 7 in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

Referring to FIG. 1, a locking system 100 is shown. The system 100 can include a plate 110 and a base 112, and the base 112 can include a first element 114 and a second element 116. In one arrangement, the first element 114 can be attached or affixed to the second element 116 with an adhesive, although the first element 114 can be attached to the second element 116 in any other suitable manner.

In one arrangement, the system 100 can be part of an audio device, such as an earbud. An earbud is an accessory commonly used with mobile communications units, such as a cellular telephone. The earbud can permit a user of the mobile unit to conduct a conversation without having to hold the mobile unit. Of course, the invention is not so limited, as the system 100 can be employed in any other suitable device.

The base 112 can include a speaker 118 and a handle 120. The plate 110 can also include a handle 122. In one embodiment of the invention, the speaker 118 can have a neck 124, which can permit a user of the system 100 to position securely the speaker 118 inside one of his or her ears. The user can grasp the handle 120 and the handle 122 when the user wishes to insert the speaker 118 in his or her ear or when the user wants to remove the speaker 118 from his or her ear.

In another arrangement, the plate 110 can include a surface area 126, and the surface area 126 can receive a decorative image 128 (not shown to scale). The decorative image 128 can be, for example, a trademark associated with a company or other organizations such as sports teams. As another example, the decorative image 128 can be a picture of a setting or an object, a phrase or a collection of symbols. In fact, the decorative image 128 can be any suitable image. The decorative image 128 can be attached or affixed to the surface area 126 of the plate 110. For example, the decorative image 128 can be affixed to the surface area 126 with an adhesive. Of course, the decorative image 128 can be secured to the surface area 126 through any other suitable means. As will be described below, the system 100 can permit a user to detachably couple the plate 110 to the base 112, which can allow the user to couple plates 110 with different decorative images 128 to the base 112.

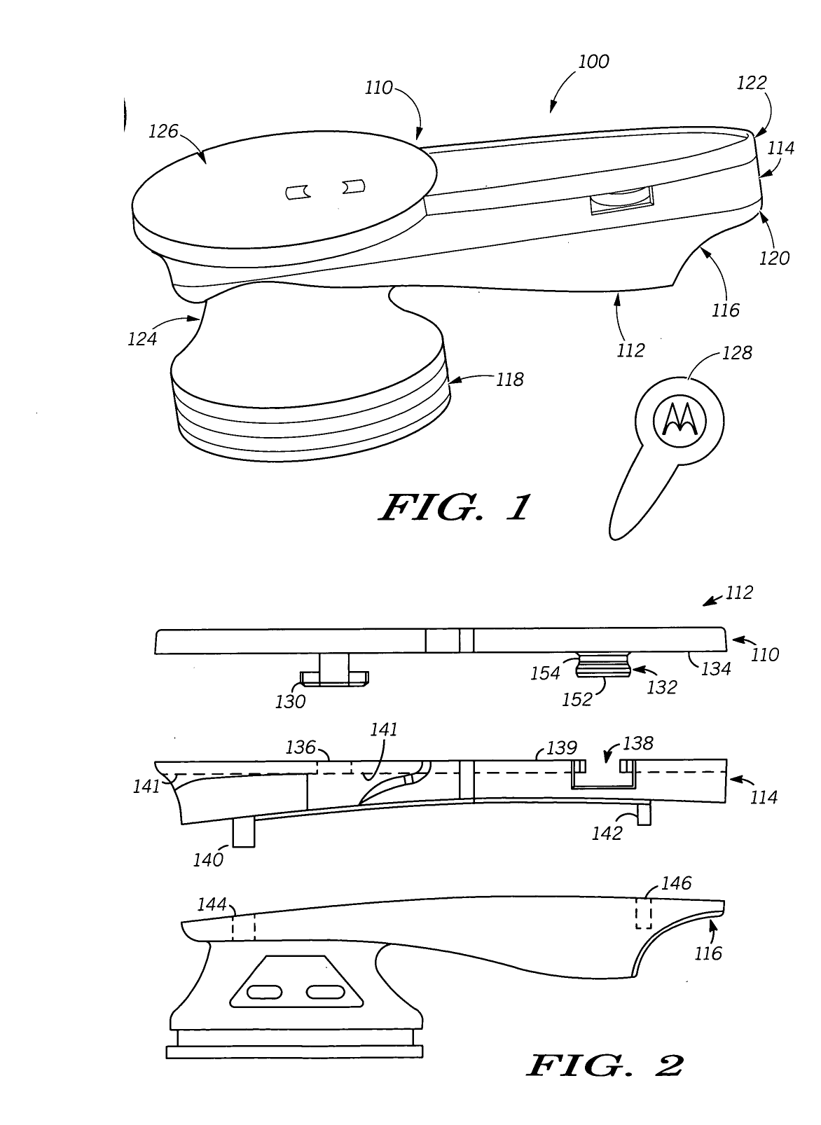

Referring to FIG. 2, an exploded side view of the system 100 is shown. Specifically, the plate 110 can include a first projection 130 and a second projection 132, and the first projection 130 and the second projection 132 can be attached to another surface area 134 of the plate 110. In addition, the base 112 can include a first slot 136 and a second slot 138 (because it is hidden in this side view, the first slot 136 is represented by broken lines). As an example, the first slot 136 and the second slot 138 can be part of the first element 114.

In one arrangement, the first slot 136 and the second slot 138 can detachably engage the first projection 130 and the second projection 132. For example, the first slot 136 can engage the first projection 130, and the second slot 138 can engage the second projection 132, and as a result, the plate 110 can couple to the base 112. Alternatively, the first slot 136 can disengage the first projection 130, and the second slot 138 can disengage the second projection 132, which can cause the plate 110 to decouple from the base 112. The first element 114 can include a top surface 139 and a bottom surface 141 (the bottom surface 141 is also represented by a broken line), and the bottom surface 141 can engage at least a portion of the first projection 130 when the first slot engages 136 engages the first projection 130. This process will be described further below.

The first element 114 of the base 112 can also include a first projection 140 and a second projection 142, and the second element 116 can include a first slot 144 and a second slot 146. The first slot 144 and the second slot 146 can respectively receive the first projection 140 and the second projection 142, and this configuration can assist in the attachment of the first element 114 to the second element 116.

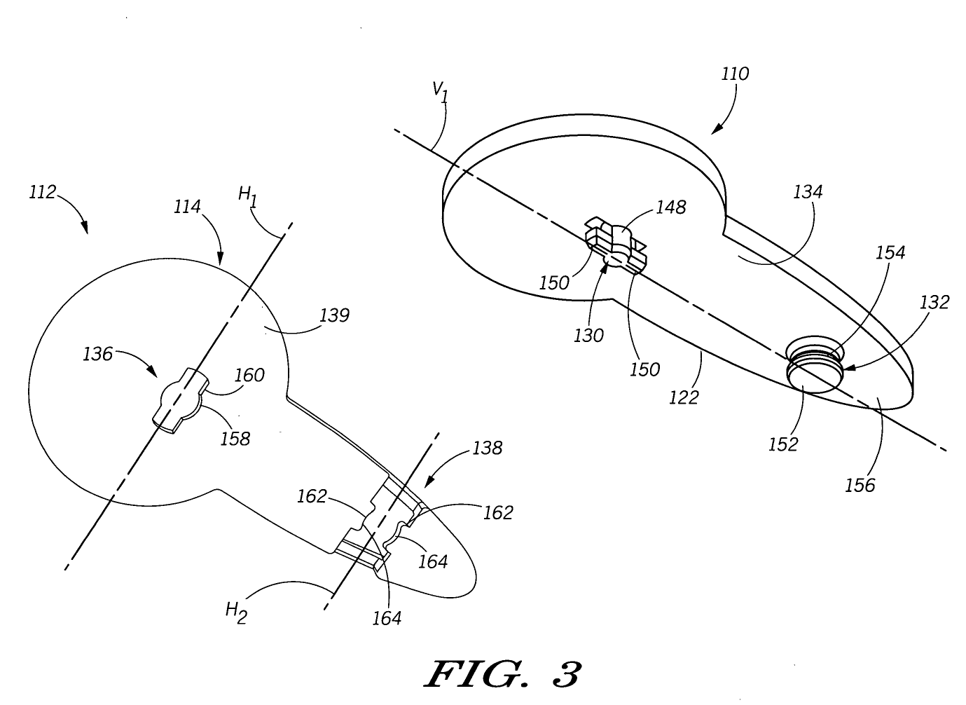

Referring to FIG. 3, the plate 110 and the first element 114 of the base 112 are shown. As illustrated, the first projection 130 can include a center portion 148, which can be at least substantially circular, and at least one wing 150. The wings 150 can be attached to the center portion 148 and can extend away from the center portion 148. In one arrangement, the wings 150 can run at least substantially along a vertical axis V₁ of the plate 110. For purposes of the invention, the phrase “at least substantially circular” can include true circular as well as slight or even moderate deviations from true circular, and the phrase “at least substantially along” can include strict adherence with the vertical axis V₁ or slight or even moderate deviations from the vertical axis V₁. Moreover, although the first projection 130 and the second projection 132 are along the same vertical axis, V₁, it is understood that these components may be positioned along different axes.

The second projection 132 can include a head 152 and a neck 154 (see also FIG. 2) in which the head 152 is attached to the neck 154, and the neck 154 is attached to the surface area 134 of the plate 110. In one arrangement, the second projection 132 can be positioned on the handle 122 of the plate 110 near an end 156 of the handle 122. It must be noted, however, that the invention is not limited in this regard, as the second projection 132 can be positioned at any other suitable location of the plate 110. It is also understood that the first projection 130 may be positioned at other suitable locations on the plate 110 other than the location at which it is shown in FIG. 3.

The first slot 136 can include at least one arc 158 and at least one extension 160 in which the extensions 160 extend away from the arcs 158. In one arrangement, the arcs 158 can engage the center portion 148 of the first projection 130, and the extensions 160 can receive the wings 150 of the first projection 130.

The second slot 138 can include at least one projection 162 in which the projection 162 can include an arc 164. In one arrangement, the second slot 138 can include a pair of opposing projections 162, which is shown in FIG. 3. As an example, these arcs 164 of the opposing projections 162 can engage the neck 154 of the second projection 132. The first slot 136 and the second slot 138 can be positioned on the top surface 139 of the first element 114 in accordance with the positioning of the first projection 130 and the second projection 132 on the plate 110. Additionally, the first slot 136 can run at least substantially along a horizontal axis H₁ of the base 112, and the second slot 138 can run at least substantially along a horizontal axis H₂ of the base 112. The phrase “at least substantially along” can include strict adherence with the horizontal axes H₁, H₂ or slight or even moderate deviations from the horizontal axes H₁, H₂.

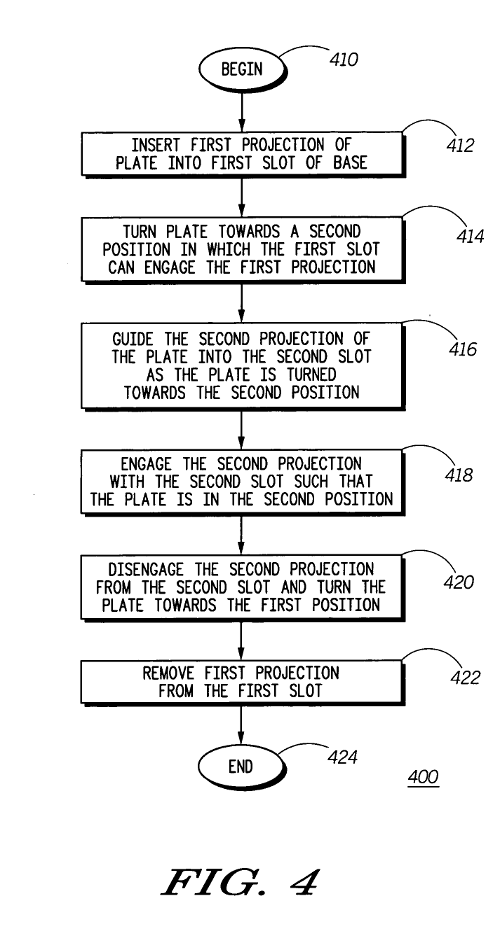

Referring to FIG. 4, a method 400 is shown that illustrates the overall operation of the invention. Reference will be continuously made to FIGS. 1-3 and 5-8 when describing the steps of the method 400. Although reference is made to the system 100 to describe the method 400, it is understood that the method 400 can be practiced with any other suitable system.

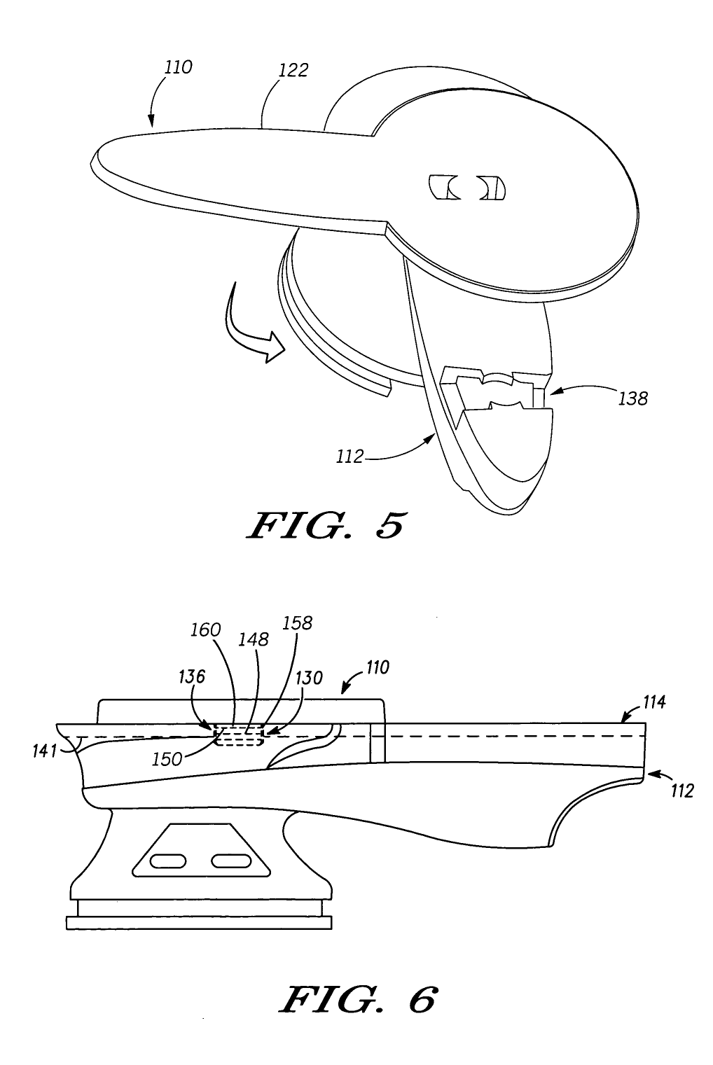

At step 410, the method 400 can begin. At step 412, the first projection 130 of the plate 110 can be inserted into the first slot 136 of the base 112. At this point, the plate 110 is in a first position, which is illustrated in FIGS. 5 and 6 (FIG. 5 shows a perspective of the system 100 with the plate 110 in the first position, and FIG. 6 shows a side view of the plate 110 and the first element 114 in the first position with the handle 122 of the plate 110 facing away). In this first position, the first slot 136 can detachably receive the first projection 130. Specifically, the extensions 160 of the first slot 136 can receive the wings 150 of the first projection 130. Additionally, the arcs 158 can receive the center portion 148.

When the plate 110 is in the first position, the handle 122 of the plate 110 can be at an angle that is approximately ninety degrees with respect to the handle 120 of the base 112. The phrase “approximately ninety degrees” can include exactly ninety degrees or slight or even moderate deviations from ninety degrees. In this first position, the plate 110 can be removed from the base 112. It is understood, however, that the first position is not limited to this particular angle or configuration. That is, the handle 122 of the plate 110 can be at any other suitable angle when the plate is in the first position.

Referring back to FIG. 4, at step 414, the plate 110 can be turned towards a second position, and the first slot 136 can engage the first projection 130. In one arrangement, the second position can be the position where the plate 110 is on top of and coupled to the base 112 (see FIG. 1). Referring to FIG. 5, a user can grasp the handle 122 of the plate 110 and can turn the handle 122 in a direction in accordance with the arrow shown. The plate 110 can also be turned in a direction that is opposite to the direction of the arrow. As the plate 110 is turned from the first position to the second position, the bottom surface 141 (see FIGS. 2 and 6) of the first element 114 of the base 112 can engage the wings 150 of the first projection 130.

Referring back to FIG. 4, the second projection 132 of the plate 110 can be guided into the second slot 138 as the plate 110 is turned towards the second position, as shown at step 416. For example, referring to FIGS. 3 and 5, as the plate 110 approaches the second position, the second projection 132 can slide within the second slot 138. The positioning of the second projection 132 and the second slot 138 (such that they correspond to one another) can allow this process to occur.

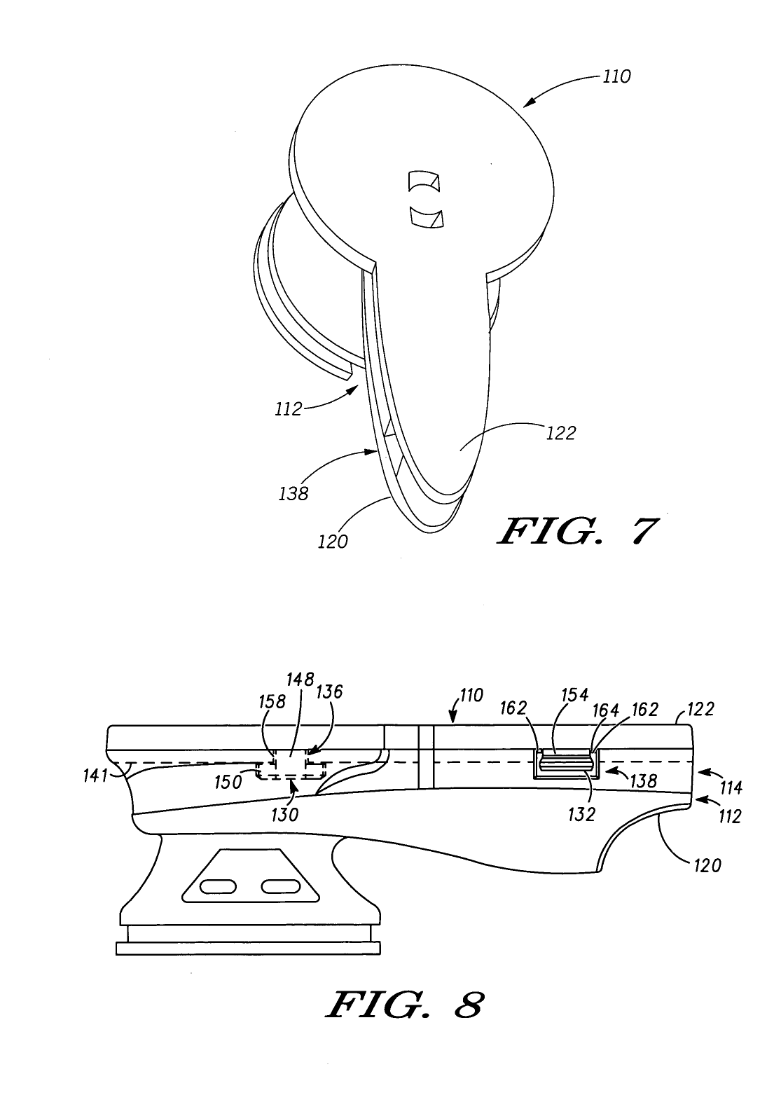

Moving back to FIG. 4, at step 418, the second slot 138 can engage the second projection 132, and the plate 110 can now be in the second position. This configuration is illustrated in FIGS. 1, 7 and 8 (FIG. 7 shows a perspective of the system 100 with the plate 110 in the second position, and FIG. 8 shows a side view of the plate 110 and the first element 114 in the second position). In the second position, the handle 122 of the plate 110 can be at least substantially parallel with the handle 120 of the base 112. For purposes of the invention, the phrase “at least substantially parallel” can include true parallel as well as slight or even moderate deviations from true parallel. The invention, however, is not limited to this particular second position, as the plate 110 can be at any other suitable angle with respect to the base 112 when the plate 110 is in the second position.

Here, the bottom surface 141 of the first element 114 can continue to engage the wings 150 of the first projection member 130. The arcs 158 of the first slot 136 can also continue to receive the center portion 148 of the first projection 130. At least in part because of this engagement, the plate 110 is coupled to the base 112, and the first slot 136 can be said to lock the first projection 130 when the plate 110 is in the second position. Additionally, the first slot 136 can be said to lock the first projection 130 as soon as the bottom surface 141 engages the wings 150 of the first projection 130, an event that can occur as the plate 110 is moved towards the second position.

When the plate 110 is in the second position, the arcs 164 of the opposing projections 162 can snap lock the neck 154 of the second projection 132. Also at least in part because of this engagement, the plate 110 can couple to the base 112, and the second slot 138 can be said to lock the second projection 132 when the plate 110 is in the second position.

The plate 110 can be removed from the base 112 in a similar manner. Referring back to FIG. 4, at step 420, the second projection 132 can be disengaged from the second slot 138 and the plate 110 can be turned towards the first position. For example, referring to FIG. 7, a user may grasp the handle 122 of the plate 110 and can force the plate 110 in a direction in accordance with the direction of the arrow. The plate 110 can also be turned towards the first position in a direction that is opposite to that of the arrow. Referring to FIG. 8, this force can cause the arcs 164 of the opposing projections 162 to disengage from or unlock the neck 154 of the second projection 132. Thus, the second slot 138 can unlock the second projection 132 as the plate 110 is turned from the second position to the first position.

Referring once again to FIG. 4, when the plate 110 reaches the first position, the first projection 130 can be removed from the first slot 136, as shown at step 422. Subsequently, the plate 110 can be removed from the base 112. For example, referring to FIGS. 5 and 6, in the first position, the bottom surface 141 of the first element 114 no longer engages the wings 150 of the first projection 130. As a result, the first slot 136 can unlock the first projection 130 in this first position, which permits the user to decouple the plate 110 from the base 112. Referring back to FIG. 4, at step 424, the method 400 can end. The user is then free to replace the plate 110 with another plate 110, which may include a different decorative image 128, in accordance with the method 400 described above. As such, the user is free to couple to the base 112 plates 110 with virtually any type of decorative image 128.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A locking system, comprising:
a plate having a first projection and a second projection, wherein at least a portion of said first projection runs at least substantially along a vertical axis of said plate, said plate also including a surface area for receiving a decorative image; and
a base having a first slot and a second slot, wherein said first slot and said second slot run at least substantially along horizontal axes of said base;
wherein said first slot detachably receives said first projection when said plate is in a first position and said second slot detachably receives said second projection as said plate is turned to a second position, wherein said first slot locks said first projection and said second slot locks said second projection when said plate is in said second position such that said plate is detachably coupled to said base.

2. The system according to claim 1, wherein said second slot unlocks said second projection as said plate is turned from said second position to said first position.

3. The system according to claim 2, wherein said first slot unlocks said first projection when said plate is in said first position such that said plate is removable from said base.

4. The system according to claim 1, wherein said first projection has a center portion that is at least substantially circular and at least one wing that is attached to and projects away from said center portion.

5. The system according to claim 4, wherein said first slot includes at least one arc that engages said center portion of said first projection and at least one extension that receives said wings of said first projection.

6. The system according to claim 5, wherein said base comprises a first element and a second element, wherein said first element is affixed to said second element, wherein said first element has a top surface and a bottom surface and said bottom surface engages said wings as said plate is turned to and stops at said second position.

7. The system according to claim 1, wherein said second projection includes a neck and a head, wherein said neck is attached to said plate and said head is attached to said neck.

8. The system according to claim 7, wherein said second slot includes a pair of opposing projections, each said projection having an arc, wherein said arcs snap lock said neck of said second projection when said plate is in said second position.

9. The system according to claim 1, wherein said base further comprises a speaker and a handle, wherein a user positions said speaker in an ear of the user and the user grasps the handle when the user wishes to insert said speaker in the user's ear and when the user wishes to remove said speaker from the user's ear.

10. The system according to claim 2, wherein said plate further comprises a handle, wherein a user grasps and turns said handle when the user wishes to turn said plate from said first position to said second position and from said second position to said first position.

11. A locking mechanism, comprising:
a plate having a first projection and a second projection; and
a base having a first slot and a second slot, wherein said first slot and said second slot detachably lock said first projection and said second projection to permit said plate to detachably couple said base;
wherein said plate includes a surface area for receiving a decorative image;
wherein a user selectively detachably couples said plate to said base by turning said plate from a first position to a second position and from said second position to said first position.

12. A plate for an audio device, comprising:
a first surface area;
a second surface area for receiving a decorative image;
a first projection; and
a second projection, said first and second projections being disposed on said first surface area;
wherein said first and second projections detachably engage a first slot and a second slot of a base of the audio device, wherein said plate couples to the base when said first and second projections engage the first and second slots and said plate decouples from the base when said first and second projections disengage the first and second slots of the base.

13. The plate according to claim 12, wherein said first and second projections of said plate disengage the first and second slots of the base when said plate is turned to a first position and wherein said first and second projections engage the first and second slots when said plate is turned to a second position.

14. A base of an audio device, comprising:
a first element having a first slot and a second slot; and
a second element having a speaker, wherein said first element is attached to said second element;
wherein said first and second slots detachably engage first and second projections of a plate of the audio device, wherein said base couples to the plate when said first and second slots engage the first and second projections and said base decouples from the plate when said first and second slots disengage the first and second projections of the plate.

15. The base according to claim 14, wherein said first and second slots of said base disengage the first and second projections of the plate when the plate is turned to a first position and wherein said first and second slots engage the first and second projections when the plate is turned to a second position.

16. A method of detachably securing a plate to a base of an audio device, comprising the steps of:
inserting a first projection of the plate into a first slot of the base, wherein the plate is in a first position;
turning the plate towards a second position, wherein the first slot engages the first projection;
guiding a second projection of the plate into a second slot during said turning the plate step; and
engaging the second slot with the second projection, wherein the plate is in the second position.

17. The method according to claim 16, further comprising the steps of:
disengaging the second projection from the second slot;
turning the plate towards the first position; and
when the plate reaches the first position, removing the first projection from the first slot.

18. The method according to claim 17, wherein the plate has a handle and the base has a handle and the handle of the plate is at approximately a ninety degree angle with respect to the handle of the base when the plate is in the first position.

19. The method according to claim 17, wherein the plate has a handle and the base has a handle and the handle of the plate is at least substantially parallel with the handle of the base when the plate is in the second position.
